(19) United States
(12) Patent Application Publication
(10) Pub. No.: US 2008/0313495 A1
(43) Pub. Date: Dec. 18, 2008

(54) Memory agent

(76) Inventor: Gregory Huff, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/818,188

(22) Filed: Jun. 13, 2007

(51) Int. Cl. G06F 11/00

(52) U.S. Cl. 714/8; 714/E11.002

(57) ABSTRACT

In one embodiment a computer system comprises a processor, a memory controller, one or more memory modules coupled to the memory controller via a communication link, and a memory agent coupled to the communication link between the memory controller and the one or more memory modules, wherein the memory agent provides services to the memory controller.

### BACKGROUND

Electronic devices such as personal computers (PCs), entertainment products, personal digital assistants (PDAs) and the like typically include one or more memory chips such as, e.g., dynamic random access memory (DRAM) chips. In computer systems, DRAM components are typically distributed as dual in-line memory modules (DIMMs). Some DIMM modules provide adequate memory capacity and input/output (I/O) performance, but provide insufficiently robust error control and correction techniques to be useful in some computing environments. This lack of robustness limits design options available to computer system designers and manufacturers.

### BRIEF DESCRIPTION OF THE DRAWINGS

FIG. 1 is a schematic illustration of one embodiment of a computer system adapted to include a memory agent.

FIGS. 2-5 are flowcharts illustrating operations which may be implemented by embodiments of a memory agent.

### DETAILED DESCRIPTION

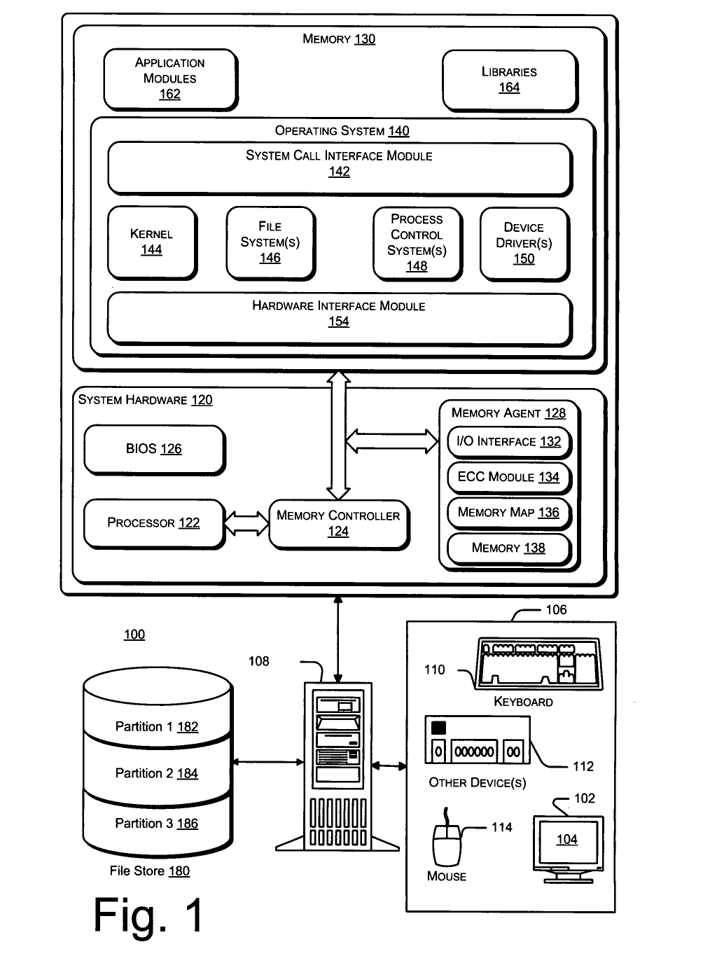

FIG. 1 is a schematic illustration of a computer system 100 adapted to include a memory agent. In the illustrated embodiment, computer system 100 may be embodied as a hand-held or stationary device for accessing the Internet, a desktop PC, notebook computer, personal digital assistant, or any other processing device that has a basic input/output system (BIOS) or equivalent.

Computer system 100 includes a computer 108 and may include one or more accompanying input/output devices 106 such as, e.g., a display 102 having a screen 104, a keyboard 110, other I/O device(s) 112, and a mouse 114. The other device(s) 112 include a touch screen, a voice-activated input device, a track ball, and any other device that enables the system 100 to receive input from a developer and/or a user.

The computer 108 includes system hardware 120 commonly implemented on a motherboard and at least one auxiliary circuit board(s). System hardware 120 including a processor 122 and a basic input/output system (BIOS) 126. BIOS 126 may be implemented in flash memory and may comprise logic operations to boot the computer device and a power-on self-test (POST) module for performing system initialization and tests. In operation, when activation of computer system 100 begins processor 122 accesses BIOS 126 and shadows the instructions of BIOS 126, such as power-on self-test module, into operating memory. Processor 122 then executes power-on self-test operations to implement POST processing.

System hardware 120 may further include a memory controller 124 and a memory agent 128. Memory controller 124 may be separate from, but coupled to processor 122, or may be integrated with processor 122. Memory controller 124 is coupled to memory module 130, which may be implemented using one or more DIMMs, via a suitable communication link such as, e.g., a peripheral component interconnect (PCI) bus, or the like. Memory agent 128 is coupled to communication interface between memory controller 124 and memory 130.

Memory agent 128 comprises a plurality of modules including an input/output interface 132, an error control/correction (ECC) module 134, a memory map 136, and a memory module 138 separate from the memory module 130. Memory agent 128 may be embodied as a separate integrated circuit, e.g., an application specific integrated circuit (ASIC) or a field programmable gate array (FPGA), or as another memory device.

Computer system 100 further includes a file store 180 communicatively connected to computer 108. File store 180 may be internal such as, e.g., one or more hard drives, or external such as, e.g., one or more external hard drives, network attached storage, or a separate storage network. In some embodiments, the file store 180 may include one or more partitions 182, 184, 186.

Memory 130 includes an operating system 140 for managing operations of computer 108. In one embodiment, operating system 140 includes a hardware interface module 154 that provides an interface to system hardware 120. In addition, operating system 140 includes a kernel 144, one or more file systems 146 that manage files used in the operation of computer 108 and a process control subsystem 148 that manages processes executing on computer 108. Operating system 140 further includes one or more device drivers 150 and a system call interface module 142 that provides an interface between the operating system 140 and one or more application modules 162 and/or libraries 164. The various device drivers 150 interface with and generally control the hardware installed in the computer system 100.

In operation, one or more application modules 162 and/or libraries 164 executing on computer 108 make calls to the system call interface module 142 to execute one or more commands on the computer's processor. The system call interface module 142 invokes the services of the file systems 146 to manage the files required by the command(s) and the process control subsystem 148 to manage the process required by the command(s). The file system(s) 146 and the process control subsystem 148, in turn, invoke the services of the hardware interface module 154 to interface with the system hardware 120. The operating system kernel 144 can be generally considered as one or more software modules that are responsible for performing many operating system functions.

The particular embodiment of operating system 140 is not critical to the subject matter described herein. Operating system 140 may be embodied as a UNIX operating system or any derivative thereof (e.g., Linux, Solaris, etc.) or as a Windows® brand operating system, for example.

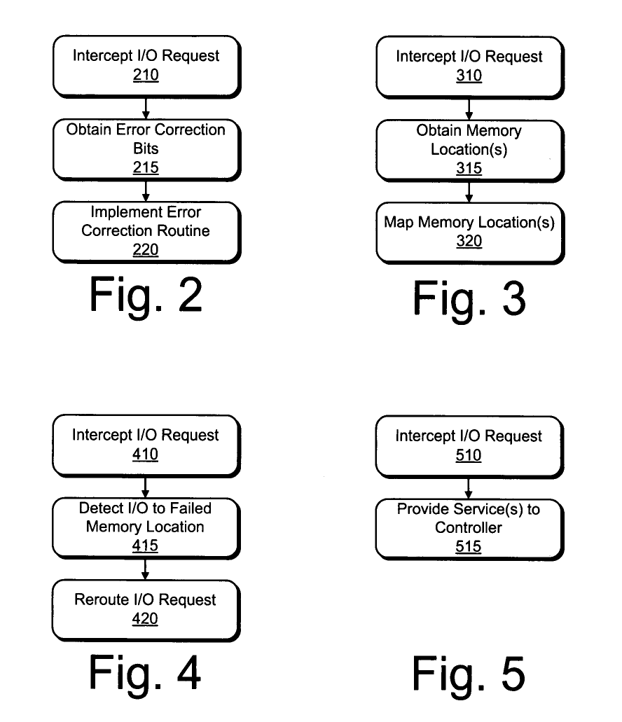

In some embodiments, the memory agent 128 cooperates with the memory controller to improve the resiliency of memory management operations associated with memory 130. FIGS. 2-4 are flowcharts illustrating operations which may be implemented by embodiments of a memory agent. In some embodiments the operations of FIGS. 2-4 may be implemented by the memory agent 128, alone or in combination with other components of the computer system 100, during memory access operations implemented by memory controller 124.

In some embodiments, memory agent 128 implements an error control/correction (ECC) routine. Referring first to FIG. 2, at operation 210, the memory agent 128 intercepts an I/O request. For example, the memory agent 128 may intercept a memory access I/O request from memory controller 124 to memory module 130. In some embodiments, memory agent 128 may actively interrupt memory I/O requests from memory controller 128, such that memory agent 128 effectively interrupts memory I/O requests from memory controller 128. In other embodiments, memory agent 128 may simply monitor memory I/O requests transmitted across the communication link between memory controller 124 and memory 130.

At operation 215 memory agent 128 obtains one or more error control/correction (ECC) bits from the memory request. The ECC bits may be inserted into a memory I/O request by an ECC routine implemented by the memory controller 124. The DIMMs used to implement memory 130 may or may not comprise logic compatible with the ECC routine implemented by memory controller 124.

At operation 220 the ECC module 134 of memory agent 128 implements an ECC routine using the one or more ECC bits obtained from the memory I/O request from the memory controller 124. The specific ECC routine implemented by the ECC module is beyond the scope of this disclosure. ECC routines are known to those skilled in the art. The salient feature is that implementing the ECC routine in memory agent 128 obviates compatibility issues between the DIMMS that are used to implement memory 130 and memory controller 124.

In some embodiments the memory agent maintains a memory map of the memory locations in the DIMMs used to implement memory 130. Referring next to FIG. 3, at operation 310, the memory agent 128 intercepts an I/O request. Operation 310 may be performed substantially in accordance with operation 210 described above. At operation 315 memory agent 128 obtains one or memory locations bits from the memory request. For example, the memory locations may correspond to memory locations in the DIMMs used to implement memory 130.

At operation 320 the memory mapping module 136 of memory agent 128 maps the memory location bits in the memory I/O request from the memory controller 124 in the memory map maintained by memory agent 128. The specific memory map implemented by the memory map module 136 is beyond the scope of this disclosure. Memory maps are known to those skilled in the art. The salient feature is that implementing the memory map in memory agent 128 obviates compatibility issues between the DIMMS that are used to implement memory 130 and memory controller 124.

In some embodiments the memory agent 128 reroutes I/O requests to failed memory locations to functional memory locations. Thus, referring next to FIG. 4, at operation 410, the memory agent 128 intercepts an I/O request. Operation 410 may be performed substantially in accordance with operation 410 described above. At operation 415 memory agent 128 obtains detects an I/O request to a failed memory location. For example, the memory agent 128 may consult the map of memory locations maintained by the memory mapping module 136 to determine whether the I/O request is directed to a failed memory location.

At operation 320 the memory mapping module 136 of memory agent 128 reroutes I/O requests directed to failed memory locations to an alternate memory location. For example, the memory mapping module 136 may reroute I/O request to an available memory location in memory module 130. Alternatively, the memory mapping module 136 may reroute the I/O request to a memory location in memory module 138 associated with memory agent 128. The memory mapping module 136 may record the alternate memory location in the memory map maintained by the memory mapping module. Thus, the memory agent 128 enables the memory controller 124 to function normally even when one or more memory locations in memory 130 fail.

In some embodiments the memory agent 128 provides one or more services to a controller in response to an I/O request. Thus, referring next to FIG. 5, at operation 510, the memory agent 128 intercepts an I/O request. Operation 510 may be performed substantially in accordance with operation 410 described above. At operation 515 memory agent 128 provides one or more services to the controller. For example, the memory agent 128 may consult the map of memory locations maintained by the memory mapping module 136 to determine whether the I/O request is directed to a failed memory location.

Thus, the memory agent 128 functions as an intermediary between memory controller 124 and the memory module 130. The memory agent 128 implements one or more routines that enhance the resiliency of the memory 130.

The methods described herein may be embodied as logic instructions on a computer-readable medium. When executed on a processor, the logic instructions cause a general purpose computer device to be programmed as a special-purpose machine that implements the described methods. The processor, when configured by the logic instructions to execute the methods recited herein, constitutes structure for performing the described methods.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

What is claimed is:

1. A computer system, comprising:
a processor;
a memory controller;
one or more memory modules coupled to the memory controller via a communication link; and
a memory agent coupled to the communication link between the memory controller and the one or more memory modules, wherein the memory agent provides services to the memory controller.

2. The computer system of claim 1, wherein the memory agent comprises an error coding module to implement an error coding scheme in the memory modules.

3. The computer system of claim 2, wherein the memory agent comprises logic to:
intercept an input/output request from the memory controller to the memory modules;
obtain error correction bits from the input/output request; and
use the error correction bits in an error correction routine.

4. The computer system of claim 1, wherein the memory agent maintains a memory map of the memory modules.

5. The computer system of claim 4, wherein the memory agent comprises logic to:
intercept an input/output request from the memory controller to the memory modules;
obtain from the input/output request, one or more memory locations identified by the memory controller; and
map the one or more memory locations identified by the memory controller to one or more memory locations in the memory modules.

6. The computer system of claim 1, wherein the memory agent comprises:
at least one supplemental memory module; and
logic to:
intercept an input/output request from the memory controller to the memory modules;
detect an input/output request to a failed memory location in the memory modules; and
reroute an input/output request from a failed memory location to a memory location in the memory agent.

7. A memory agent comprising:
an input/output interface to intercept an input/output operation from a memory controller to one or more memory modules; and
one or more service modules to provide one or more services to the memory controller.

8. The memory agent of claim 7, wherein the memory agent comprises an error coding module to implement an error coding scheme in the memory modules.

9. The memory agent of claim 8, wherein the memory agent comprises logic to:
intercept an input/output request from the memory controller to the memory modules;
obtain error correction bits from the input/output request; and
use the error correction bits in an error correction routine.

10. The memory agent of claim 7, wherein the memory agent maintains a memory map of the memory modules.

11. The memory agent of claim 10, wherein the memory agent comprises logic to:
intercept an input/output request from the memory controller to the memory modules;
obtain from the input/output request, one or memory locations identified by the memory controller; and
map the one or more memory locations identified by the memory controller to one or more memory locations in the memory modules.

12. The memory agent of claim 7, wherein the memory agent comprises:
at least one supplemental memory module; and
logic to:
intercept an input/output request from the memory controller to the memory modules;
detect an input/output request to a failed memory location in the memory modules; and
reroute an input/output request from a failed memory location to a memory location in the memory agent.

13. A method comprising:
intercepting, in a memory agent, an input/output operation from a memory controller to one or more memory modules; and
providing one or more services to the memory controller.

14. The method of claim 13, further comprising implementing an error coding scheme in the memory modules.

15. The method of claim 14 wherein implementing an error coding scheme in the memory modules comprises:
obtaining error correction bits from the input/output request; and
using the error correction bits in an error correction routine.

16. The method of claim 13, further comprising memory agent maintains a memory map of the memory modules.

17. The method of claim 16, further comprising:
obtaining from the input/output request, one or memory locations identified by the memory controller; and
mapping the one or more memory locations identified by the memory controller to one or more memory locations in the memory modules.

18. The method of claim 13, further comprising:
detecting an input/output request to a failed memory location in the memory modules; and
rerouting an input/output request from a failed memory location to a memory location in the memory agent.
